(19) United States
(12) Patent Application Publication
(10) Pub. No.: US 2008/0142188 A1
(43) Pub. Date: Jun. 19, 2008

(54) Production Method of Consumable Electrode for Consumable Electrode Arc Remelting and End Face Cutter for Use Therein

(76) Inventor: Yuzou Ishigami, Hyogo (JP)

Correspondence Address: CLARK & BRODY, 1090 VERMONT AVENUE, NW, SUITE 250, WASHINGTON, DC, 20005, US

(21) Appl. No.: 11/883,349

(22) PCT Filed: Oct. 26, 2005
(86) PCT No.: PCT/JP2005/019656

§ 371 Date: Jul. 31, 2007

(30) Foreign Application Priority Data
Feb. 4, 2005 (JP) 2005-028648

(51) Int. Cl. H01S 4/00; H05B 7/08

(52) U.S. Cl. 164/495; 29/592.1; 409/139; 165/97; 373/90; 219/129

(57) ABSTRACT

A method for producing a consumable electrode for remelting and an end face cutter for use in the method in which an ingot made in a consumable electrode arc remelting process is used as a material for the consumable electrode, are characterized in that said ingot can be set so that its centerline axis in a longitudinal direction lies horizontally and an end face of said ingot is machined by milling to be flat, the end face being connected with a stub, the stub holding the consumable electrode. In melting the consumable electrode, the present invention makes it easier to machine the bottom face of ingot that is to be mounted onto the stub or to perform conditioning such as cleaning the surface, which results in cutting man-hours and processing steps required for those operations and improving a product yield, thus enabling it to be widely used as a method for producing an ingot by the VAR process and contributing to the development of the relevant technology.

### TECHNICAL FIELD

The present invention relates to a method for producing a consumable electrode to be used in a consumable electrode arc remelting process for titanium, zirconium and the like, wherein an ingot obtained by primary melting is used as a consumable electrode material, and relates to an end face cutter for preparing end faces of the ingot.

### BACKGROUND ART

As a melting process in making an ingot as a material to be used in processing a metal such as titanium or zirconium having high melting point as well as extremely high activity at high temperatures, a consumable electrode vacuum arc remelting process (hereinafter, referred to as “VAR”) is widely adopted. Especially, in production of titanium metals and titanium alloys, the VAR process accounts for 85% or more of worldwide melting capacity.

FIG. 1 is an illustration schematically explaining a structure of a furnace used in the VAR process. A consumable electrode 1 as a melting material is suspended to the centerline of a mould 2 made of copper, the mould being water-cooled at its outer surface, and electric arcs are discharged to the clearance between the lower end of the consumable electrode and a bottom of the mould by virtue of conducting direct electrical current wherein the consumable electrode is set negative and the mould being set positive in a vacuum or in an inert gas atmosphere. While molten metal that comes off and drop from the consumable electrode forms a melt pool 4 due to heat by electric arcs, the consumable electrode moves down gradually to adjust the clearance and electric current between the pool 4 and the consumable electrode 1 to thereby sustain discharging stable electric arcs 3, so that the consumable electrode melts continuously from its lower end, and the melt pool 4 is incrementally solidified from its bottom layer, whereby completion of the melting of the whole consumable electrode material yields an ingot 5 in the copper mould.

As regards raw materials for melting, typically with particles that are made by crushing sponge-type metals obtained through reduction, comminuted scraps and/or alloy elements, when needed, are blended to be compressed and consolidated by a press to thus yield compressed blocks that are referred to as compacts or briquettes, and then, these are placed side by side, aligned and subjected to welding, thereby yielding a consumable electrode. Sponge-type, for example, sponge titanium is porous and has excellent compression-deformability, so that shapes in a lump form can be easily formed. The melting which is applied using the consumable electrode made by compressing such sponge-type crude materials is called a primary melting and the ingot thus obtained is called a primary ingot.

In general, a primary melting is quality-wise unstable since a consumable electrode is inhomogeneous and contains residues from reduction reactions, so a primary ingot ends up in comprising an inhomogeneous composition and having numerous defects on its surface and at its inside. Therefore, remelting by the VAR process in such a way that the primary ingot is used as a consumable electrode, i.e., a secondary melting, is applied to obtain a much more robust ingot. At this occasion, the primary ingot becomes the consumable electrode for the secondary melting as it is, so the copper mould for the secondary melting needs to be larger in size than that for the primary melting. When necessary, a tertiary melting or more, a multiplex melting, can be applied.

In a melting furnace for the VAR process shown in FIG. 1, a consumable electrode 1 is mounted onto a stinger rod 6 via a stub 7, the stinger rod having an upping/downing mechanism. Typically, the stub is made of the same metal with the consumable electrode, and is configured such that one end thereof is mounted onto the stinger rod in a releasable manner such as screw threading or bolts-and-nuts fastening, while the other end is welded to the consumable electrode 1.

In case of a primary melting, a consumable electrode is made in such a way that compacts made of compressed sponges are assembled and welded, while a consumable electrode to be used for a secondary or. multiplex melting is usually constructed by welding the bottom portion of an ingot obtained at the previous melting to the stub, and the top portion of the ingot turns to the lower end of the consumable electrode to start melting.

Such a method for producing titanium ingots is, for example, described in “Titanium Metals and Applications thereof” (1987 edition, page 16-23) authored by Kusamichi, Hidetake, printed by Nikkann Kougyou Newspapers Co., or in Japanese Patent Application Publication No. Hei 10-25527 or 2003-41330 in detail.

### DESCLOSURE OF THE INVENTION

From the viewpoint of an improvement of the melting efficiency in a VAR melting furnace, a gap between an outer surface of a consumable electrode and an inside surface of water-cooled copper mould is set not to be large and the copper mould is configured to be large in axial length relative to its radius, so in order to prevent discharging side arcs, a centerline axis of the consumable electrode and a centerline axis of the copper mould needs to coincide with each other to thereby keep a uniform gap between the inner cylindrical surface of copper mould and the outer cylindrical surface of consumable electrode at every circumferential position thereof along the axial length as much as possible.

To that end, in the case where compacts are assembled to make a consumable electrode for a primary melting, when a specific fixture so as to construct a straight consumable electrode is utilized to let the compacts sit in line and weld them, subsequently followed by mounting them to a stinger rod, the centerline axis of the stinger rod, i.e., the centerline axis of the copper mould, is fully aligned with the centerline axis of the consumable electrode and the welding to the stub is carried out.

In the secondary melting or the multiplex melting that uses the ingot for the consumable electrode, the bottom face of the ingot made by the previous melting needs to be welded to the stub. Meanwhile, the bottom face of the ingot ought to have a similar shape to that of the bottom of the water-cooled copper mould, so that as the usage frequency thereof increases, the mould distorts to cause the bottom face of ingot to be non-flat, in a concavo-convex manner, while the central region thereof on the whole becomes convex commonly. Therefore, when the centerline-alignment and the welding to the stub as it is are carried out, the resultant clearances in the peripheral region where to be welded likely cause welding defective such as lack of welding strength. Besides, since there essentially exists an insufficient, partial contact between the stub and the ingot, an overall contact area for passing an electric current ends up in being reduced to thereby cause troubles such as causing a local heat generation during melting to offset the centerline axis of the consumable electrode aligned in the mould.

In the mean time, when the bottom face of ingot is machined to be flat and is welded with a stub, a large-sized turning lathe, being used for surface finishing of the ingot to be sent to a next processing step such as forging or rolling, has been used in the machining. But, in machining the bottom face of ingot by such a large-sized turning lathe, there are problems shown below.

A top portion of ingot after melting is typically made in such a way that a central region thereof becomes concave on the whole due to shrinkage during solidification while a peripheral region protrudes in a crown form. Further, the stirring of melt by virtue of applying a magnetic field for the purpose of homogenization makes the protrusion in a crown form to be much higher. When the bottom face of ingot is machined, the top portion thereof needs to be firmly gripped by a chuck that is disposed to the revolving axis of a turning lathe. But, since the protrusion height is too much relative to the length of fingers of the chuck, the gripping force therein become deficient to thereby fail in establishing a firm gripping engagement, which is also affected by the uneven protrusion height.

As such, in order to machine the bottom face thereof, the protrusion in a crown form of the top portion needs to be cut off first so as to assure a stable gripping by the chuck of the turning lathe. In adapting the shape of the top portion so as to assure a firm gripping by the chuck, it is mostly reliable to cut it off by the turning lathe. Therefore, firstly, the bottom portion is gripped by the chuck of the turning lathe, followed by cutting off the top portion, and then, the ingot is turned the other way round so that the top portion is gripped and the machining is carried out.

However, in the case where a significantly long and heavy cylindrical ingot is machined by a large-sized turning lathe, a mere chuck by the turning lathe cannot afford to hold the workpiece horizontally, so that a ring-like supporting jig is provided at the intermediate length position of the ingot. In this regard, the centering of the entire revolving body has to be made not only at the chuck position but also at the length-wise intermediate supporting jig position. For machining by the turning lathe, this kind of cumbersome set-up adjustments have to be repeated twice, and since the protrusions in a crown form of the top portion has to be cut off and scrapped, a product yield becomes low.

The object of the present invention is to provide a method for machining the bottom face of ingot and an apparatus for use therein, the ingot being used as a consumable electrode materiak, wherein in the melting as of a secondary or multiplex melting that the ingot is to be used for the consumable electrode in the VAR process, a centerline axis of the consumable electrode is adjusted in aligned relation with a centerline axis of a stinger rod, the stinger rod having functions of suspending and upping/downing the consumable electrode, and wherein a stub is welded so as to assure sufficient passage of electric current.

The gist of the present invention pertains to the following.
(1) A method for producing a consumable electrode for remelting in which an ingot made in the VAR process is used as a material for the consumable electrode, wherein an end face of said ingot is machined by milling to be flat, the end face being connected with a stub, the stub holding the consumable electrode.
(2) The method for producing a consumable electrode for remelting according to (1) above, wherein: the ingot is set in such a way that its centerline axis in a longitudinal direction lies horizontally; said centerline axis of the ingot is set in parallel with a rotating shaft of a face milling cutter; said milling cutter is provided so as to freely move across the plane perpendicular to said axis; and an end face of said ingot is machined to be flat.
(3) The method for producing a consumable electrode for remelting according to (1) or (2) above, wherein, for a cylindrical ingot: a base plate having a plurality of rotary rollers rotatably arranged in a circle about the centerline axis in a longitudinal direction is provided to support the ingot; and the ingot is immovably held when the end face thereof is machined.
(4) The method for producing a consumable electrode for remelting according to any of (1)-(3) above, wherein, for a cylindrical ingot: a base plate having a plurality of rotary rollers rotatably arranged in a circle about the centerline axis in a longitudinal direction of the cylindrical ingot is provided to support the ingot; the ingot sits in a stationary manner, being immovably held, when the end face thereof is machined; and the ingot is caused to revolve when its surface is cleaned such that foreign substances on the ingot surface are removed by means of a polishing fixture or the like.
(5) An ingot-end-face cutter for use in producing the consumable electrode by the method according to any of (1)-(4) above, comprising: a base plate having pairs of supporting rotary rollers, which enables an ingot to be set in such a way that its centerline axis in a longitudinal direction lies horizontally and to revolve about said axis; a cutter for use in machining an end face of the ingot to be flat by milling, the end face being perpendicular to the longitudinal axis of the ingot; a lock-up device capable of immovably holding the ingot when being machined; and a cleaning device capable of removing extraneous matters from the cylindrical implosion surface of the ingot while allowing the ingot to revolve.

According to the method for producing a consumable electrode for use in remelting by the present invention, when an ingot is used as a consumable electrode material for remelting by the VAR process, it becomes easy to machine the bottom face of ingot that is to be mounted onto the stub as well as to perform conditioning such as cleaning the surface that is required in processing the ingot into the consumable electrode, thus enabling to cut man-hours and processing steps required for those operations, while improving a product yield.

### BRIEF DESCRIPTION OF THE DRAWINGS

FIG. 1 is a diagram schematically explaining a structure of a consumable electrode vacuum arc remelting furnace.

FIG. 2 is a diagram schematically explaining an apparatus by the present invention to be adopted for machining a bottom face of and for cleaning the surface of the ingot that is used as a consumable electrode.

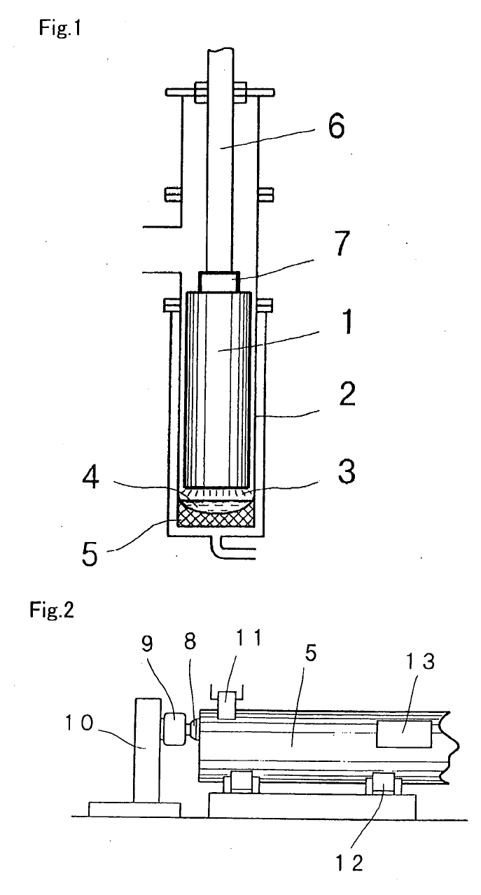

### BEST MODE FOR CARRYING OUT THE INVENTION

In an ingot to be used as a consumable electrode in the VAR process, its bottom face is machined to be flat and perpendicular to the longitudinal centerline axis thereof wherein machining by a turning lathe is carried out, which is cumbersome and entails huge man-hours. In this regard, the present inventor made various investigations on the possible simplification of and the man-hours reduction of the operations above.

The biggest problem among all to be solved is that the entire body of a significantly long and heavy ingot is supported to revolve just for the purpose of machining its bottom face to be flat. To make the entire body revolve, it takes many hours to carry out a set-up step such as adjusting supporting and centering. Therefore, if it becomes possible to machine the bottom face of the ingot to be flat and perpendicular to the centerline axis of the ingot without having the entire ingot revolved, the above preparatory set-up will be streamlined remarkably.

Accordingly, as results of studying the means to be adopted, there came up with the method such that: an ingot lies horizontally and is immovably held; a face milling cutter is adopted; the centerline axis of the ingot is kept in parallel with the rotating axis of the milling cutter; and a cutter head, disposed with a rotating mechanism for rotating the milling cutter, traverses on and machines the face perpendicular to the centerline axis of the ingot.

FIG. 2 is a diagram schematically explaining an example of the embodiment of this innovated method, in which there is shown an apparatus comprising: a base plate having rollers 12 in place wherein an ingot to be processed into the consumable electrode is held thereon; a cutter head 9 including a milling cutter 8 and a holding/traversing mechanism 10 thereof; and a device 13 having functions of cleaning the ingot surface. The following is described in detail with reference to FIG. 2 above.

A cutter head 9 disposed with a face milling cutter 8 along with its rotating mechanism is capable to move forward or backward in its rotating-axis or Z-axis direction and to be locked up at an arbitrary length-wise position, and is mounted onto a holding/traversing mechanism 10 which allows said head at the arbitrary length-wise position to move freely on a plane including X- axis and Y-axis that are at right angle to each other, the plane being perpendicular to the Z-axis.

Since it is not necessary to make the ingot to revolve as needed in case of a turning lathe operation, the ingot is set on a base plate having two pairs of blocks in place so as to be in parallel with an axial direction for the ingot wherein each pair of blocks is constructed to make an opening angle of 90-degree. Just by setting the ingot-centerline axis direction determined by the two pairs of blocks to be in parallel with the milling rotating shaft and by laying the ingot on them, the positioning is completed and no centering is required. Just replacing these blocks with pairs of rotatable rollers 12 enables the ingot to revolve about its centerline axis.

The ingot 5 laid on these pairs of rollers 12 is immovably held by a lock-up device 11, operated hydraulically or likewise, when its bottom face is machined by a milling cutter 8.

Insofar as the ingot is supported either by such pairs of blocks or pairs of rollers, any change of the ingot diameter can be accommodated and should not cause any problem. Further, configuring the base plate having either pairs of blocks or pairs of rollers in place to be movable up and down, in combination with the feeding/positioning mechanism of the milling cutter head, enables the bottom face of the ingot with any diameter to be machined flat by the same machining apparatus without altering the parameters.

The reason that the rotatable rollers are used in supporting the ingot is: freeing a lock-up device 11 enables the ingot to revolve about its axis.

On the surface of the ingot obtained by melting, foreign substances such as splashes during arc melting, which easily come off, are attached. In particular, there adhere much of salts such as MgCl₂, the reduction-incurred residue, on the ingot surface after the primary melting which adopts sponges as primary raw materials, and these extraneous matters are attributed to increase incorporation of impurities during following melting which ought to use such ingot as a consumable electrode. Therefore, before deploying the ingot for the consumable electrode, the ingot surface has to be cleaned thoroughly.

In machining the bottom face of ingot by a turning lathe, it is possible to clean the surface by brushing or the like while it revolves after being set onto the turning lathe, but it is highly likely that the foreign substances to come off drop on the sliding rail of the turning lathe to thereby give damage to the turning lathe. In this regard, in the prior art, the ingot used to be placed on a leveler plate disposed with rotatable rollers thereon and get rotated for cleaning the surface, and then get transferred to the turning lathe for setting and machining the bottom face thereof.

Since the present invention employs a base plate for machining the bottom face wherein the base plate has the same structure with this leveler plate that was used for surface cleaning, just providing a cleaning device 13 enables to clean the surface and to machine the bottom face of such a huge, heavy ingot while it is set on the same base plate without transferring it, wherein said cleaning device is disposed with a rotating brush or the like being configured to be movable in parallel with the centerline axis of the ingot.

As such, operations of transferring and center alignment can be simplified drastically, so that the time interval between completion of a primary melting and start-up of a secondary melting can be shortened substantially, thereby enabling to set to the secondary melting while the heat of the primary melting remains in the consumable electrode, which thus produces an effect that the melting time of the secondary melting can be shortened either.

### EXAMPLES

In order to confirm the effects of the producing method of a consumable electrode for use in melting according to the present invention, an embodiment example is made such that: the apparatus shown in the foregoing FIG. 2 is employed, and a primary ingot of 880 mm in diameter, about 3800 mm in length and 8400 kg in weight is made; a secondary ingot of 1000 mm in diameter is produced; and the comparison is made with the conventional case where machining is carried out by the turning lathe. The obtained results are shown in the following.

First, it became unnecessary to remove the protrusions in a crown form on the top portion of the primary ingot to thereby improve a yield by 0.2%. Next, the time interval between the evacuation of the ingot out of the furnace after the primary melting and the completion of welding the consumable electrode for the secondary melting to the stub was shortened by 43% on average.

Further, the required time for melting from beginning to end is cut by about 10%. This is attributable to the merit that at a time when the secondary melting started, the surface temperature of the consumable electrode was approximately 20° C. in the prior art, while getting to 100° C. or so in the present invention, and thus, the remaining heat in the ingot after the primary melting contributed to reduce the required energy for the secondary melting.

### INDUSTRIAL APPLICABILITY

The present invention in relation to the method for producing a consumable electrode for use in remelting, makes it easier to machine the bottom face of ingot that is to be mounted onto the stub as well as to perform conditioning such as cleaning the surface that is required in processing the ingot into the consumable electrode when the ingot is used as a consumable electrode material for remelting by the VAR process, which results in cutting man-hours and processing steps required for those operations and an improvement of a product yield, thus enabling it to be widely used as a method for producing an ingot by the VAR process and contributing to the development of the relevant technology.

1. A method for producing a consumable electrode for remelting in which an ingot made in a consumable electrode arc melting process is used as a material for the consumable electrode, wherein an end face of said ingot is machined by milling to be flat, the end face being connected with a stub, the stub holding the consumable electrode.

2. The method for producing a consumable electrode for remelting according to claim 1, wherein:
said ingot is set in such a manner that its centerline axis in a longitudinal direction lies horizontally;
said centerline axis of the ingot is set in parallel with a rotating axis of a face milling cutter;
said milling cutter is provided so as to freely move across the plane perpendicular to said axis; and
the end face of said ingot is machined to be flat.

3. The method for producing a consumable electrode for remelting according to claim 1, wherein, for a cylindrical ingot:
a base plate having a plurality of rotary rollers rotatably arranged in a circle about the centerline axis in a longitudinal direction is provided to support the ingot; and
the ingot is immovably held when the end face thereof is machined.

4. The method for producing a consumable electrode for remelting according to claim 1, wherein, for a cylindrical ingot:
a base, plate having a plurality of rotary rollers rotatably arranged in a circle about the centerline axis in a longitudinal direction of the cylindrical ingot is provided to support the ingot;
the ingot sits in a stationary manner, being immovably held, when the end face thereof is machined; and
the ingot is caused to revolve when its surface is cleaned such that foreign substances on the ingot surface are removed by means of a polishing fixture or the like.

5. An ingot-end-face cutter for use in producing the consumable electrode for remelting by the method according to claim 1, comprising:
a base plate having pairs of supporting rotary rollers, which enables said ingot to be set in such a way that its centerline axis in a longitudinal direction lies horizontally and to revolve about said axis;
a cutter for use in machining an end face of the ingot to be flat by milling, the end face being perpendicular to the longitudinal axis of said ingot;
a lock-up device capable of immovably holding said ingot when being machined; and
a cleaning device capable of removing extraneous matters from the cylindrical implosion surface of the ingot while allowing said ingot to revolve.

6. The method for producing a consumable electrode for remelting according to claim 2, wherein, for a cylindrical ingot:
a base plate having a plurality of rotary rollers rotatably arranged in a circle about the centerline axis in a longitudinal direction is provided to support the ingot; and
the ingot is immovably held when the end face thereof is machined.

7. The method for producing a consumable electrode for remelting according to claim 2, wherein, for a cylindrical ingot:
a base plate having a plurality of rotary rollers rotatably arranged in a circle about the centerline axis in a longitudinal direction of the cylindrical ingot is provided to support the ingot;
the ingot sits in a stationary manner, being immovably held, when the end face thereof is machined; and
the ingot is caused to revolve when its surface is cleaned such that foreign substances on the ingot surface are removed by means of a polishing fixture or the like.

8. The method for producing a consumable electrode for remelting according to claim 3, wherein, for a cylindrical ingot:
a base plate having a plurality of rotary rollers rotatably arranged in a circle about the centerline axis in a longitudinal direction of the cylindrical ingot is provided to support the ingot;
the ingot sits in a stationary manner, being immovably held, when the end face thereof is machined; and
the ingot is caused to revolve when its surface is cleaned such that foreign substances on the ingot surface are removed by means of a polishing fixture or the like.

9. An ingot-end-face cutter for use in producing the consumable electrode for remelting by the method according to claim 2, comprising:
a base plate having pairs of supporting rotary rollers, which enables said ingot to be set in such a way that its centerline axis in a longitudinal direction lies horizontally and to revolve about said axis;
a cutter for use in machining an end face of the ingot to be flat by milling, the end face being perpendicular to the longitudinal axis of said ingot;
a lock-up device capable of immovably holding said ingot when being machined; and
a cleaning device capable of removing extraneous matters from the cylindrical implosion surface of the ingot while allowing said ingot to revolve.

10. An ingot-end-face cutter for use in producing the consumable electrode for remelting by the method according to claim 3, comprising:
a base plate having pairs of supporting rotary rollers, which enables said ingot to be set in such a way that its centerline axis in a longitudinal direction lies horizontally and to revolve about said axis;
a cutter for use in machining an end face of the ingot to be flat by milling, the end face being perpendicular to the longitudinal axis of said ingot;
a lock-up device capable of immovably holding said ingot when being machined; and
a cleaning device capable of removing extraneous matters from the cylindrical implosion surface of the ingot while allowing said ingot to revolve.

11. An ingot-end-face cutter for use in producing the consumable electrode for remelting by the method according to claim 4, comprising:
a base plate having pairs of supporting rotary rollers, which enables said ingot to be set in such a way that its centerline axis in a longitudinal direction lies horizontally and to revolve about said axis;
a cutter for use in machining an end face of the ingot to be flat by milling, the end face being perpendicular to the longitudinal axis of said ingot;
a lock-up device capable of immovably holding said ingot when being machined; and
a cleaning device capable of removing extraneous matters from the cylindrical implosion surface of the ingot while allowing said ingot to revolve.
